(19) United States
(12) Patent Application Publication
(10) Pub. No.: US 2013/0115031 A1
(43) Pub. Date: May 9, 2013

(54) GRAIN BIN SWEEP CONTROL

(71) Applicant: The GSI Group, LLC, Assumption, IL (US)

(72) Inventors: Gregory J. Trame, Rochester, IL (US); Robert C. Brush, Mattoon, IL (US); Luke M. Flessner, Pana, IL (US)

(73) Assignee: The GSI Group, LLC, Assumption, IL (US)

(21) Appl. No.: 13/672,155

(22) Filed: Nov. 8, 2012

Related U.S. Application Data
(60) Provisional application No. 61/557,048, filed on Nov. 8, 2011.

(51) Int. Cl. B65G 43/00; B65G 65/46

(52) U.S. Cl. CPC B65G 43/00; B65G 65/466
USPC 414/307; 318/5

(57) ABSTRACT

A method for controlling the advancement of a grain bin sweep into a grain pile in a grain bin comprises monitoring the amperage of the auger drive and controlling the sweep drive motor based on the amperage load of the auger drive. The speed and direction of the sweep is controlled to maintain the load on the auger drive in a desired range. Hence, the speed of the sweep is slowed if the amperage load on the auger drive exceeds a desired maximum set point by a first amount; the direction of the sweep is reversed if the load on the auger drive exceeds the maximum set point by a second amount which is greater than the first amount; and the forward speed of the sweep is increased if the load on the auger drive falls below a minimum.

### CROSS-REFERENCE TO RELATED APPLICATIONS

This application claims priority to U.S. Application No. 61/557,048 filed Nov. 8, 2011.

### STATEMENT REGARDING FEDERALLY SPONSORED RESEARCH OR DEVELOPMENT

Not Applicable.

### BACKGROUND OF THE INVENTION

This application relates to sweeps for grain bins and the like, and in particular, to a control for a grain bin sweep.

Grain bin sweeps are very common in the industry, as are basic controls for such systems. Typically bin sweeps rely on drive wheels or traction drives of some kind to push the sweep into the grain mass. Such drives can lose traction with the bin floor and thus reduce the effectiveness of the sweep. This often requires the operator to closely monitor the sweep operation and in many cases enter the bin in order to get the sweep to regain traction. Positive drive sweeps seek to create a positive mechanical link between the propulsion of the sweep and the floor. This can be accomplished by the use of a gear and track or the like. Such sweeps are commonly driven by employing hydraulic motors which are relatively easy to control manually, but are prohibitively costly to control automatically.

### BRIEF SUMMARY

Briefly stated, a controller for controlling the travel of a bin sweep within bin and a method for controlling the bin sweep are disclosed. The bin sweep comprises an auger, an electric auger drive which drives the auger; and an electric sweep drive motor which rotationally drives the bin sweep about an axis of rotation, and a controller which is in communication with the motors to control the motors.

In accordance with one aspect of the method, the method comprises monitoring the amperage of the auger drive and electronically and automatically controlling the sweep drive motor based on the amperage load of the auger drive. If the amperage load on the auger drive exceeds a desired maximum set point by a first amount while the sweep is being driven forwardly into a grain pile in the grain bin, the advancement of the sweep into the grain pile is slowed or stopped until the amperage load on the auger drive falls back to, or below, the desired maximum set point.

If the amperage load on the auger drive exceeds the desired maximum set point by a second amount larger than the first amount while the sweep is being driven forwardly into a grain pile, the direction of the sweep is reversed to remove the sweep from the grain pile. The rearward direction of the sweep is maintained until the amperage load on the auger drive falls to or below the desired maximum set point, at which time, the direction of the sweep drive motor is reversed to again drive the sweep into the grain pile.

If the amperage load on the auger drive falls below a desired minimum set point, the speed of the advancement of the sweep into the grain pile will be increased until the amperage load on the auger drive is between the desired maximum set point and the desired minimum set point.

The sweep is controlled in this manner until it is determined that the grain bin is empty. In one variation, the step of determining if the grain bin is empty comprises monitoring the amperage load on the auger drive; whereby, it is determined that the grain bin is empty if the amperage load on the auger drive drops below the desired minimum set point by a determined amount for a determined period of time. In another variation, the step of determining if the grain bin is empty comprises monitoring the angular position of the bin sweep and determining if the bin sweep has completed a full revolution about an axis of rotation.

In accordance with a further aspect of the method, the sweep drive motor is a variable speed electric motor. In this aspect, the method comprises monitoring the amperage of the auger drive and electronically and automatically controlling the speed of the sweep drive motor based on the amperage load of the auger drive to adjust the speed of advancement of the sweep into a grain pile to maintain the amperage load on the auger drive within a predetermined amperage load range; said load range having an upper limit and a lower limit.

If the amperage load on the auger drive exceeds the upper limit of the desired set point range by at least a determined amount, the direction of the sweep is reversed to remove the sweep from the grain pile. This rearward direction of the sweep is maintained until the amperage load on the auger drive falls to or below the upper limit of the desired set point range, at which time, the direction of the sweep drive motor is reversed to again drive the sweep into the grain pile.

The method can include steps of determining the approximate unload rate of grain based on the amperage load of the auger drive and determining the approximate amount of grain removed up to a given point in time based on the approximate unload rate.

The method can include an initial step of adjusting the auger drive speed and torque to begin unloading of grain.

The method can further include a step of delaying activation of the sweep drive until the load amperage on the auger drive falls below a determined threshold.

Further, the bin sweep can include an auger shield which, at least in part, covers the auger. Here, the initial step would include a step of retracting the shield to achieve a set auger drive load amperage.

The control system comprises a controller which is in operative communication with the bin sweep drive to activate and deactivate the bin sweep drive motor and to switch the bin sweep drive motor between a forward direction and a reverse direction. The controller is also in electrical communication with said auger drive to receive signals indicative of the amperage load of the auger drive, and the controller controls the bin sweep drive in response to the signals received regarding the amperage load of the auger drive to maintain the auger drive within a predetermined amperage load range, the load range having an upper limit and a lower limit.

In one embodiment, the sweep drive is a variable speed drive, and controller controls the speed of the sweep drive, and hence the speed with which the sweep is advanced into a grain pile, in response to the signals received from the auger drive regarding the amperage load of the auger drive to maintain the auger drive within the predetermined amperage load range.

If the controller determines that the amperage load on the auger drive exceeds the upper limit of the desired load range by a first amount, the controller stops advancement of the sweep into the grain pile, and if the controller determines the amperage load on the auger drive to exceed the upper limit of the load range by a second determined amount, the controller reverses the direction of the sweep drive motor to remove the sweep from the grain pile. The rearward direction of the sweep is maintained until the amperage load on the auger drive falls to or below the upper limit of the load range, at which time, the controller reverses the direction of the sweep drive motor to again drive the sweep into the grain pile.

In accordance with an aspect of the controller, the bin sweep drive is a positive drive.

In accordance with an aspect of the controller, the bin sweep drive motor is an electric motor.

In accordance with an aspect of the controller, the controller is adapted to determine the approximate unload rate of grain based on the amperage load of the auger drive.

In accordance with an aspect of the controller, the controller is adapted to determine the amount of grain unloaded up to a given point in time based on the approximate unload rate.

In accordance with an aspect of the controller, the controller controls the direction of the sweep until the controller determines that the grain bin is empty, or nearly empty, of grain.

In accordance with an aspect of the controller, includes a position encoder secured to the sweep assembly. The encoder is in electrical communication with the controller, and emits signals indicative of the angular position of the sweep in the grain bin. The controller can then determine if the bin is empty of grain based on the angular position of the sweep relative to the initial angular position of the sweep.

In accordance with an aspect of the controller, the grain bin sweep comprises two or more sweep assemblies. In one variation, each of the two or more sweep assemblies is independently controlled by the controller. In another variation, each of the two or more sweep assemblies is controlled by the controller to move in unison.

### BRIEF DESCRIPTION OF THE SEVERAL VIEWS OF THE DRAWINGS

FIG. 1 is a perspective view of a bin sweep positioned within a grain bin;

FIG. 2 is an enlarged view of the bin sweep;

FIG. 3 is a further enlarged view of the bin sweep to show the drive of the bin sweep in more detail;

FIG. 4 is an enlarged view of the bin sweep in the area of the center unload point about which the sweep rotates showing the auger drive for the bin sweep;

FIG. 5 is a block diagram schematic of a control system for the sweep;

FIG. 6 is an image of a control panel for the control system;

FIG. 7 is an image of an amperage set-up screen of the control system;

FIG. 8 is an image of a commodity set-up screen of the control system;

FIG. 9 is an image of an auger and bin size set up screen of the control system;

FIG. 10 is an image of a first informational screen of the control system showing motor amperage information;

FIG. 11 is an image of a second informational screen of the control system which shows the position of the sweep in the grain bin;

FIG. 12 is an image of an “emergency stop” screen; and

FIG. 13 is a flow chart of an automatic control of the sweep;

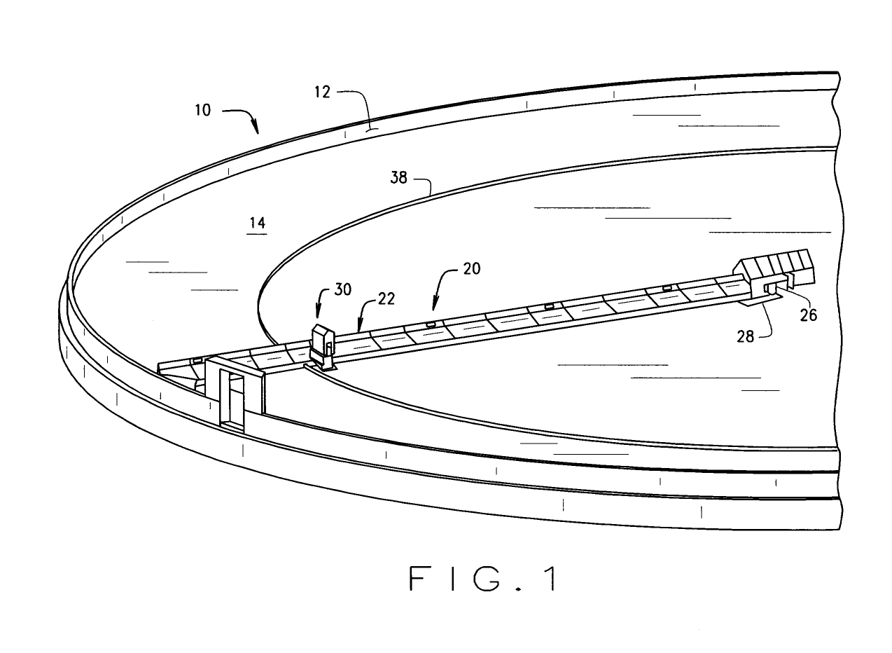

Corresponding reference numerals will be used throughout the several figures of the drawings.

### DETAILED DESCRIPTION OF THE INVENTION

The following detailed description illustrates the invention by way of example and not by way of claimed limitation. This description will clearly enable one skilled in the art to make and use the claimed invention, and describes several embodiments, adaptations, variations, alternatives and uses of the claimed invention, including what we presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

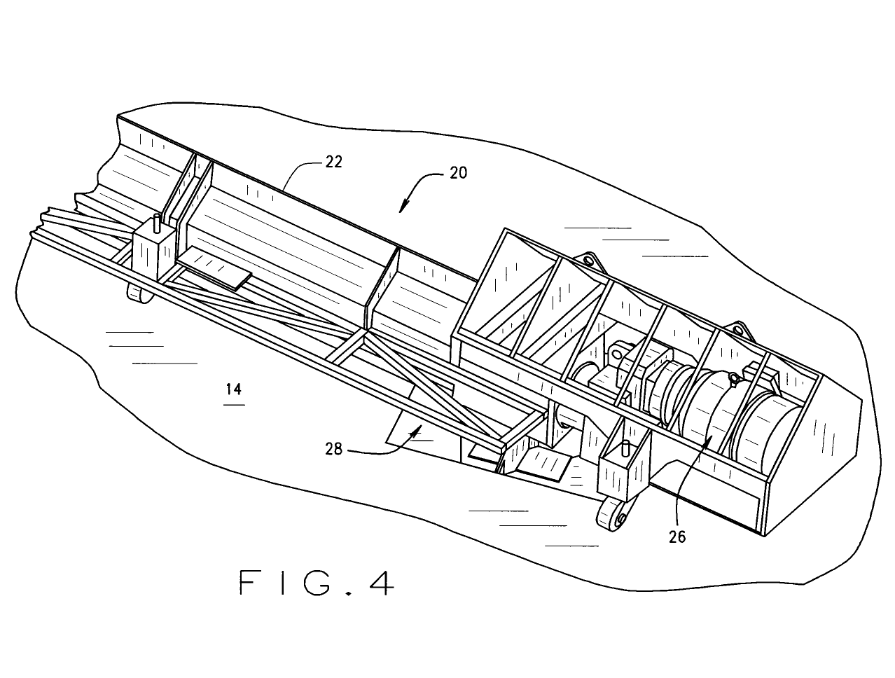

A bin 10, such as a grain bin, has an outer wall 12 (only part of which is shown) and a floor 14. The wall 12 and floor 14 define a space which is closed with a roof (not shown). The bin 10 includes one or more openings 28 (FIG. 4) in the floor 14 through which grain can flow to be delivered under the force of gravity to an unloading conveyor. During unloading, after the grain reaches a particular level within the grain bin 10, the grain will cease to flow readily to the grain bin's unloading outlet 28.

A bin sweep 20 is provided to facilitate delivery of grain to the unloading outlet or opening 28. The bin sweep 20 extends radially from the opening 28. In the Figures, the bin is provided with a single bin sweep. In such a case, the opening 28 is generally positioned in the center of the bin floor, and the bin sweep reaches substantially to the bin wall 12. Depending on the size (diameter) of the bin, there may be two or more bin sweeps. In this instance, two or more sweeps can extend from the same unloading opening. If there are multiple openings, each opening can have one, two, or more sweeps extending from the opening.

The sweep 20 includes an auger assembly 22 comprising a shield 24 which partially surrounds and rotatably supports an auger (not shown). The auger can be driven by an electrical auger drive 26 which is mounted adjacent to the opening 28 at one end of the auger. The auger drive 26 is contained within a housing to protect the drive from grain in the bin. Further, the auger assembly is rotatably affixed to a support at the opening 28 to create an axis about which the auger assembly rotates. Hence, the sweep effectively rotates about the unloading opening 28, and the auger is operated to deliver grain to the opening 28 for unloading from the bin.

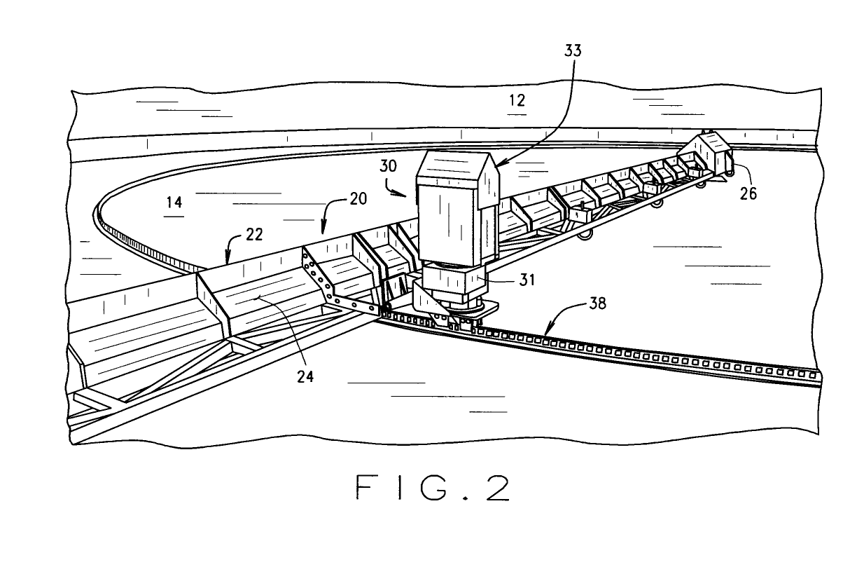

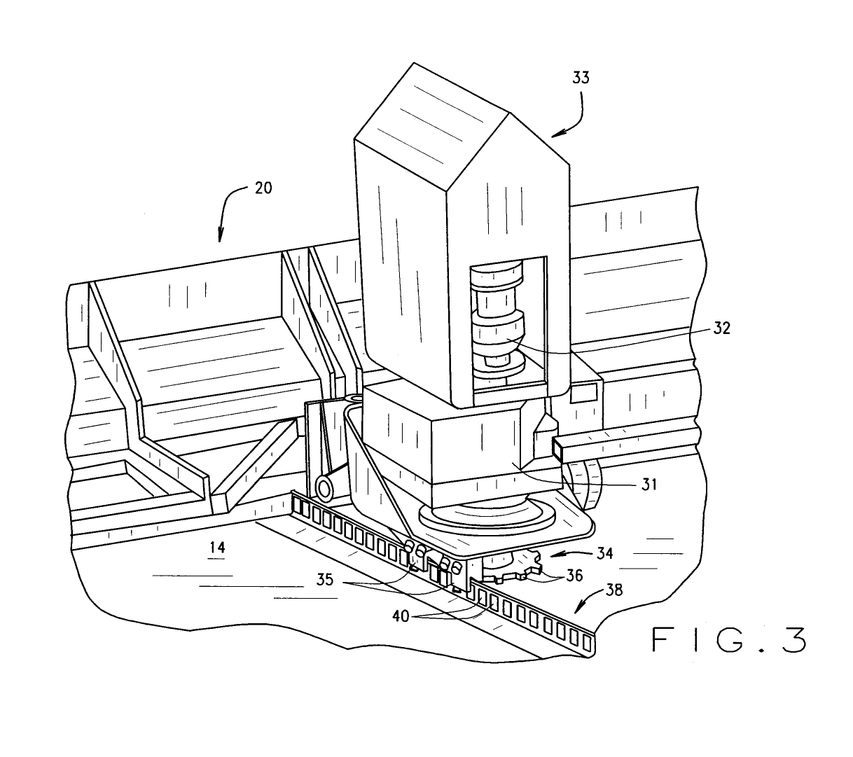

A bin sweep drive 30 (FIGS. 2 and 3) moves the sweep around the bin. The bin sweep drive 30 includes a gear box 31 and an electric motor 32. The motor 32 is shown to be contained in a motor housing 33. The motor 32 is preferably a variable speed electric motor. A gear 34 having a plurality of teeth 36 is mounted to the output shaft of the electric motor 32 to be rotated by the motor 32. The sweep drive 30 is positioned at a location along the length of the auger assembly 22. The gear 34 engages a slotted track 38 which defines a circle positioned on the bin floor to be engaged by the gear 34. The track 38 includes a plurality of slots or openings 40. The track slots 40 and the gear teeth 36 are sized and positioned such that the gear teeth 36 will engage the track slots as the gear is rotated by the drive motor 32. Hence, as the gear rotates, the engagement of the gear teeth 36 with the track slots 40 will positively drive the sweep assembly 22 in a desired direction. The drive assembly 30 includes a fingers 35 which extend downwardly from a base on which the gearbox 31 is mounted. The fingers 35 extend along the track 38 on a side of the track 38 opposite the gear 34. The fingers will facilitate maintaining an engagement between the gear 34 and the track 38. Hence the bin sweep drive 30 is a positive drive.

The sweep drive 30 is connected to a control system 40 that is capable of operating the drive motor 30 and sweep in both a manual and automatic mode. With reference to FIG. 5, the control system 40 comprises a controller (or CPU) 42 which is electrically connected to the motor 32 to control the motor 32. An encoder 44 (such as a rotary or shaft encoder) is affixed to the auger assembly 22, for example, at the axis of rotation of the auger assembly. The encoder 44 is electrically connected to, and in communication with, the controller 42. The encoder is a position encoder which produces a signal, that is received by the controller 42, indicative of the angular position of sweep assembly 22 in the bin. In addition, the controller 42 is in electrical communication with the auger drive 26 to operate and control the auger drive and to receive information from the auger drive related to the load amperage on the auger drive 26.

As will be discussed below, the bin sweep can be operated in a manual or an automatic mode. When the bin sweep is being operated in the automatic mode, the controller 42 will activate and control the sweep drive motor 32 based on the input received regarding load amperage on the auger drive 26. The control system controls the starting and stopping (and optionally the speed) of the auger in the sweep as well as the forward, idle, and reverse motion of the sweep around the bin. That is, the controller 42 controls both the auger drive 26 and the sweep drive motor 32. The control system 40 is able to monitor the load on the auger drive 26 in order to determine how full the auger may be at any moment.

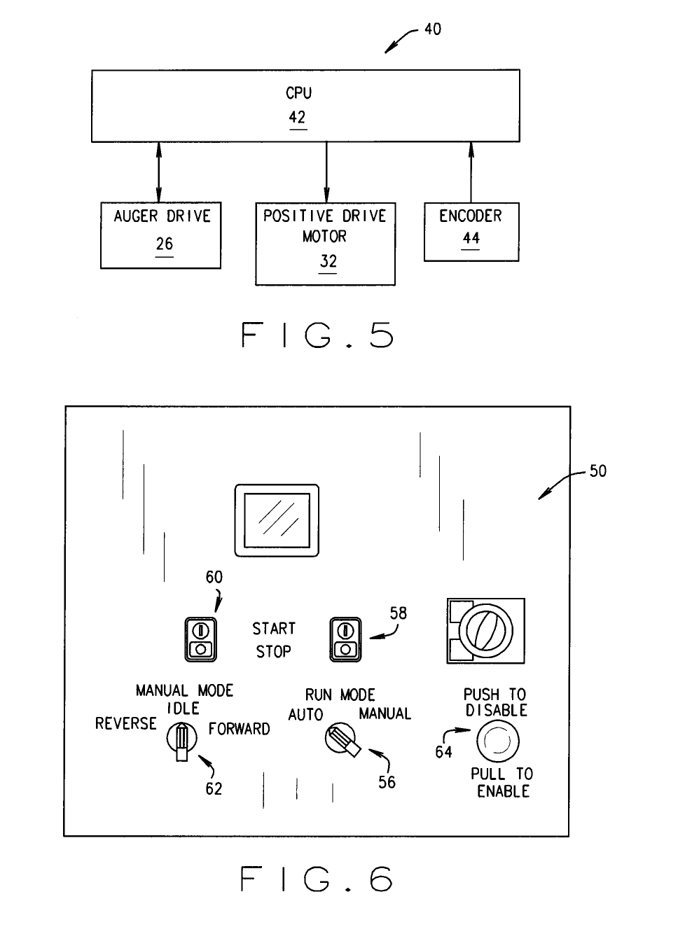

Turning to FIG. 6, the control system 40 includes a control panel 50 having a monitor 52. The control panel allows for operator input. The monitor 52 includes a plurality of screens (52a-f) which prompt for input that provide information to the operator regarding the performance of the sweep and the bin. The control panel 50 includes a mode switch 56 which allows for the operator to select either an automatic control mode or a manual control mode. In the manual control mode, the operator activates the auger drive 26 and the sweep drive 30, and controls the sweep drive 30. To this end, the panel 50 includes start and stop switches/buttons 58 and 60 to activate the auger drive and sweep drive 30, respectively. Additionally, the panel 50 includes a sweep drive control switch 62 which allows for the operator to control the direction of the auger assembly 22 (i.e., forward or reverse) or to stop the movement of the bin sweep in either direction (idle). A start/stop button 64 is provided to start or stop the system if the system is in the automatic mode. Additionally, the control panel may include an “operator present” switch (not shown). This operator present switch can, for example, be a foot switch which would be depressed for manual operation of the bin sweep, and would need to remain depressed to continue operation of the bin sweep. This “operator present” switch could be replaced with other means that would stop operation or prevent operation of the bin sweep. For example, the control panel could be provided with an “electric eye” which would detect the presence of an operator, and which would prevent or stop operation if the operator stepped away from the control panel. Alternatively, the “operator present” switch could be replaced with a bin door switch, a light curtain, or other means which would stop operation, or prevent operation, of the bin sweep if the bin door were opened during operation of the sweep. The motor start and stop buttons 58 and 60, and positive drive switch 62 are activated only when the system is operating in the manual mode. When the system is operating in the automatic mode, these buttons/switches are disabled. In FIG. 5, the switches and buttons are shown as physical switches and buttons. However, the control panel could include a touch screen, and the buttons and switches could be “smart” or “virtual” buttons and switches represented on the touch panel.

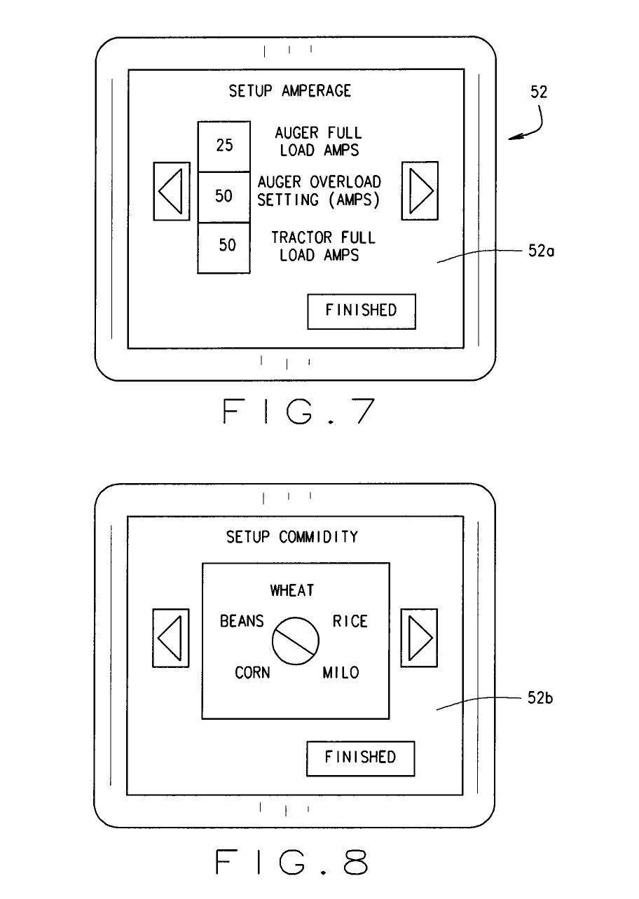

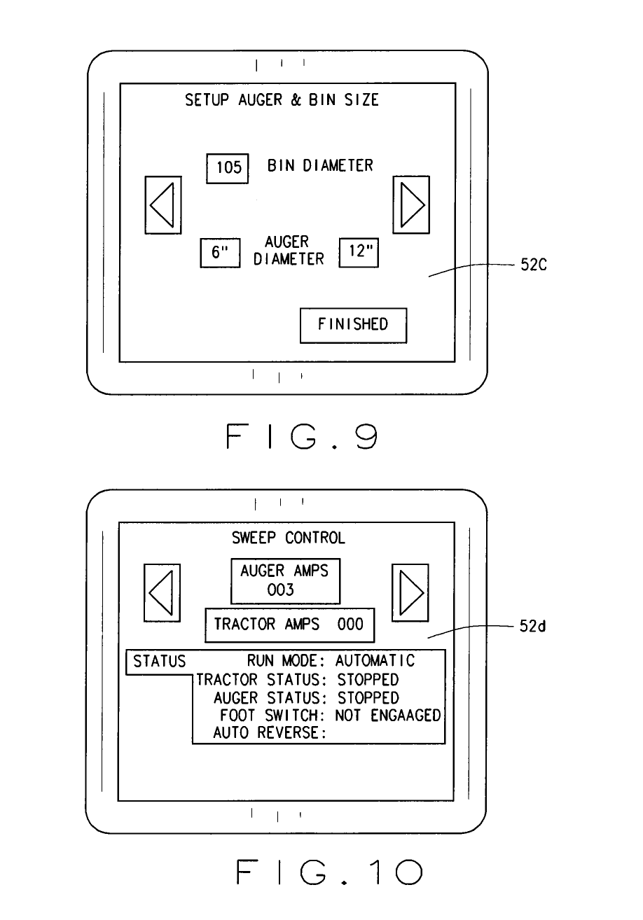

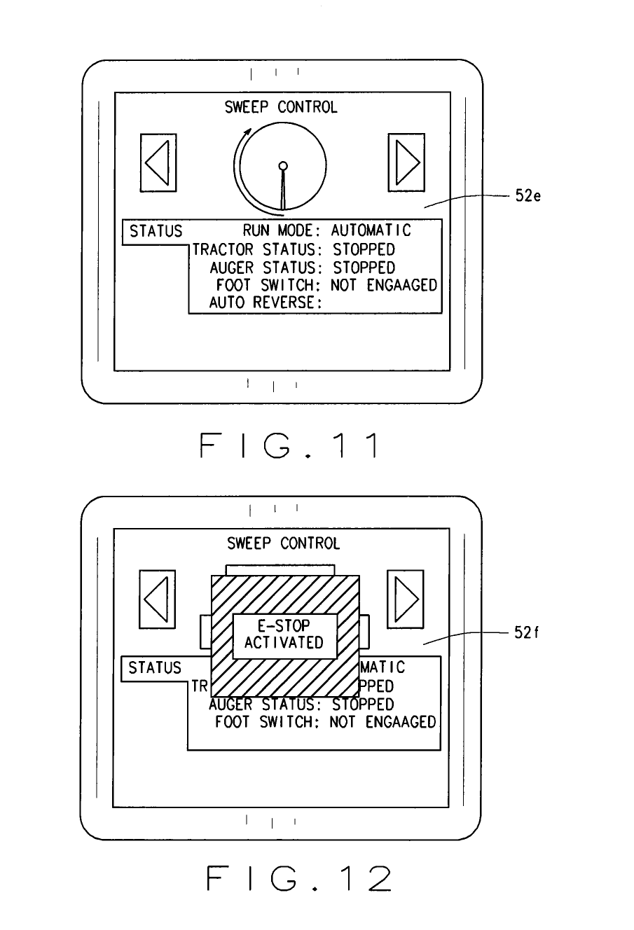

Lastly, control panel 50 includes a monitor or screen 52 which, as noted, includes a series of “set-up” screens and informational screens. FIG. 7 shows an amperage set-up screen 52a. The amperage set-up screens enables the operator to enter values for the full load amperage of the auger drive 26, the auger overload setting (in amps) and the full load amperage of the sweep drive motor 30. FIG. 8 shows a commodity selection screen 52b at which the operator informs the system what commodity (i.e., type of grain) is contained in the grain bin. FIG. 8 shows selections for beans, corn, rice and milo (sorghum plant grain). These selections are illustrative. The system could provide for other types of grain and for a different number of choices of grain (i.e., more or less than the four choices shown). FIG. 9 shows an auger and bin set-up screen at which the operator sets the diameter of the bin 10 and the length of the sweep assembly 22. FIGS. 10 and 11 are informational screens. FIG. 10 displays the amperage currently being drawn by the auger drive 26. In smaller size print, the screen shows the amperage currently being drawn by the sweep drive motor 30. Additionally, below the amperage information, the screen 52d displays the mode setting (manual or automatic), the sweep drive motor status (started or stopped), the auger drive status (started or stopped), the “operator present” switch status (engaged or not engaged), and the auto-reverse status (which would inform the operator of the direction of the sweep drive motor when operated in automatic mode). FIG. 11 shows a screen 52e which generates an image of the position of the sweep assembly 22 in the bin based on the information received from the encoder 44, along with an arrow indicating the direction of travel of the sweep. Lastly, the screen 52f of FIG. 12 is shown when the bin sweep 20 is stopped by means of the emergency stop switch.

Any other desired information could be displayed as well. Such other information can include estimated unload rate and estimated bushels remaining in the bin. As can be appreciated, these estimates will use information input in the commodity set-up screen (FIG. 8) and the auger and bin size set up screen (FIG. 9). Further, the control system 40 can provide visualizations of the above information, rather than just textual information. The bushels remaining calculation can additionally be based on (i) the number of bushels of grain in the bin prior to the start of operation of the sweep (which can be input or calculated) and (ii) the rate at which grain is being unloaded from the bin (which can be based on either input from the grain unloader or the rate of forward motion of the sweep, the type of grain being unloaded, and the load on the auger drive 26).

As noted above, in automatic mode, the controller 42 uses the load on the auger drive 26 to control the advancement of the auger assembly 22 into the grain pile. That is, control of the sweep drive motor 32 is based on the load on the auger drive motor 26. If the load on the auger drive 26 exceeds a predetermined set point by determined amounts, the controller 42 will control the sweep drive motor 32 to slow or stop the forward travel of the auger assembly 22. Thus, if the load exceeds the predetermined set point by a first amount, the controller 42 will stop the forward advance of the auger assembly 22 into the grain pile; and if the load exceeds a second, higher, amount, the controller will reverse the direction of travel of the sweep and move the bin sweep out of the grain pile until the amperage load on the auger drive 26 is reduced to, or below, a predetermined minimum set point. When this minimum set point is reached, the controller will reinitiate forward travel of the auger assembly 22 to drive the auger assembly 22 into the grain pile. This minimum set point can be equal to the predetermined set point, or can be lower than the predetermined set point by a determined amount.

The controller can control the sweep in essentially two manners. If the sweep drive is a variable speed drive (which is preferred), the controller can control the speed of the sweep into the pile to maintain the percent of motor full load amp (FLA %) of the auger drive at a desired level (or within predetermined levels). Thus, as the FLA % of the auger drive exceeds the desired range, the speed of the advancement of the sweep into the grain pile can be reduced, and when the FLA % of the auger drive drops below the desired range, the speed of the advancement of the sweep into the grain pile can be increased. Such control of the speed may be provided by a PID control loop or the like. However, if the sweep drive is not a variable speed drive (i.e., if it is a single speed drive), then when the % FLA of the auger drive exceeds the desire range, the advancement of the sweep into the grain pile will cease until the % FLA of the auger drive falls back into the desired range.

To operate the bin sweep 20 in manual mode, the operator must initially set the control system to manual mode using the mode switch 56. Once in the manual mode, the operator will need to depress the “operator present” switch to activate the panel for any of the other switches to be activated. As noted above, the “operator present” switch can be replaced with any number of devices which will prevent operation, or stop operation, of the bin sweep when the operator is not present at the control panel or if the bin door is opened. In the manual mode, the operator activates the auger drive 26 and positive sweep drive motor 30 using the auger and positive sweep drive switches 58 and 60, respectively. The operator will then control the direction and speed of the sweep 20 with the selector switch 62 based on auger load information, shown in screen 52d (FIG. 10). As noted above, the “operator present” switch (or its equivalent) will need to be closed throughout the full bin emptying cycle.

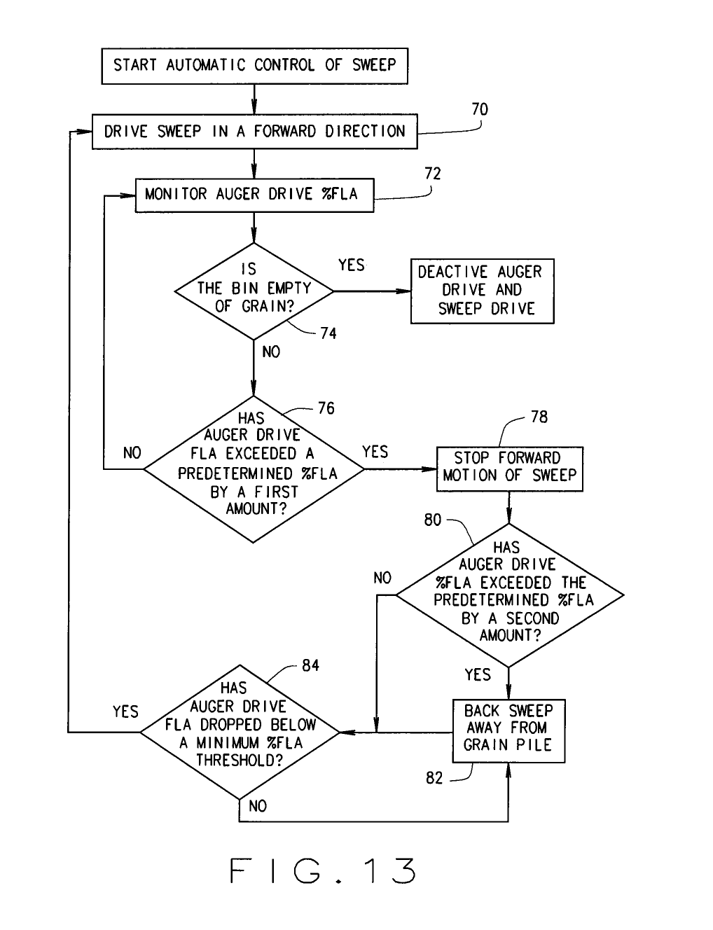

With reference to FIG. 13, in automatic mode, the operator initiates selects the automatic mode using the mode switch 56. The operator then enters the information of the various set-up screens. Once the information is entered, the bin sweep operation is started by pressing the start button 64. The positive sweep drive motor 30 will then be controlled by the controller 42 based on auger drive amperage. For example, 30 seconds after the operator presses the start button, the controller will, at 70, activate the positive sweep drive motor 30 to move the auger assembly 22 forward. The controller at 72 receives information regarding the % FLA (full load amperage) of the auger drive 26 to control the speed and direction of the sweep. The controller controls the drive motor 30 to maintain the auger drive at a % FLA between a desired set point (such as about 85% FLA) and a minimum % FLA (such as about 50% FLA). At 74, the controller determines if bin is empty, at which point the controller deactivates the auger and sweep drives and ends the operation. As long as the bin is not empty, the controller monitors the % FLA of the auger drive 26. If controller determines at 76 that the % FLA has exceeded a % FLA set point (such as about 85%) by a certain amount (such as about 5%), such that the % FLA is at, for example about 90% FLA, the controller, at 78, stops forward motion of the auger assembly 22 to allow the auger to direct grain toward the outlet 28. The controller continues to monitor the auger drive % FLA at 80. If the auger drive % FLA continues to rise, and exceeds the set point % FLA by a certain amount (such as about 15%, so that the auger drive motor is operating at, for example about 100% FLA), the controller will, at 82, reverse the positive drive motor to move the auger assembly 22 away from the grain pile. The controller will continue to monitor the drop in auger drive amperage at 84 as the auger assembly is moved away from the grain pile. When the auger drive amperage falls below the minimum % FLA, the control system will reverse the direction of the auger assembly, and at 70, drive the auger assembly forwardly into the grain pile. The controller then enters a normal control loop (i.e., maintaining the auger drive at between the minimum set point and desired set point) until the grain bin is emptied of grain. These numbers set forth above are merely illustrative, and could be changed as desired. The positive sweep drive motor 30 could be started with a delay other than 30 seconds (or even no delay). Additionally, different auger drive loadings can be used to control the positive sweep drive 30 motor.

The bin sweep will continue to run in automatic mode until it is determined that the bin is empty of grain or until the bin sweep is deactivated by the operator. Most simply, the control system 40 can determine that the bin is effectively empty when the auger assembly 22 completes one complete revolution of the bin. Alternatively, the control system can determine that the bin is empty, as noted above, by monitoring the load on the auger drive. If the load on the auger drive falls below the minimum % FLA for more than a determined period of time (for example, the time needed for the auger assembly to make a complete revolution), the controller can determine that the grain bin is empty, or substantially empty, of grain. Alternatively, the controller can determine that the grain bin is empty based on a calculated bin unloading rate and an initial determination of the number of bushels of grain that were in the bin when the sweep was activated. Furthermore, once the bin is determined to be effectively “empty”, the controller could send the sweep on a second, “higher speed” pass of the bin in order to clean out any debris remaining on the bin floor.

As noted above, the bin can be provided with two or more sweeps. In such an instance, the sweeps would be operated independently of each other. In one “multi-sweep” embodiment, the sweeps are independent of each other. Having an accurately controlled sweep with a variable speed drive and position encoder will allow for the production of such a system, and will allow for the operation of a plurality of sweeps that are positioned in an angular relationship to one another. These independent sweeps can be moved independently of each other. The advantages of a multi-sweep system are that it places more uniform loads on the grain bin as it unloads and obviously has the potential to unload the bin at a faster rate. In another variation of the “multi-sweep” embodiment, the plurality of sweeps are positioned in a (rigid) fixed angular relationship to one another and are operated in unison. Hence, the sweeps will advance into or retreat from the grain pile based on the conditions of all of them simultaneously. For example, if one sweep is overloaded, all of the sweep drives will stop and reverse at the same time and at the exact same speed without causing undue stress on the rigid “arms” of the sweep structure. As can be appreciated, this ability is enabled by the use of a positive drive, variable speed drives, a position encoder, and a controller.

Also, a sweep is typically left in the bin and covered with grain, and must first be uncovered (by grain) before operation of the sweep begins. This can be a laborious process as the auger itself often must be freed of grain. In the automatic mode, the sweep control 40 would additionally be able to provide a startup mode in which the full torque of the sweep drive motor 30 could be applied in a controlled manner. Once it was determined that the auger drive was operating in the desired FLA % range, the controller would proceed with moving the sweep into the remaining grain pile. Stated differently, the controller would not activate the sweep drive 30 until it determines that the auger drive is operating within the desired FLA % range. This initial step of adjusting the speed and torque of the auger drive can also facilitate the beginning of the unloading of grain from the bin. Further, the auger shield 24 can be retracted as part of this startup mode. Retraction of the shield will expose the auger to the grain, and will facilitate setting an auger drive FLA %.

In order to assist with the startup mode, the sweep could employ a variable speed drive on its primary auger to allow a more controlled unload force and rate. The sweep could also have a retractable shield over the open side of the auger that would be controlled by a motor and opened by the controller during startup.

As various changes could be made in the above constructions without departing from the scope of the invention, it is intended that all matter contained in the above description or shown in the accompanying drawings shall be interpreted as illustrative and not in a limiting sense.

1. A method for controlling the travel of a bin sweep inside of a grain bin, the bin sweep comprising an auger, an electric auger drive which drives the auger; and an electric sweep drive motor which rotationally drives the bin sweep about an axis of rotation; the method comprising monitoring the amperage of the auger drive and electronically and automatically controlling the sweep drive motor based on the amperage load of the auger drive;
whereby, if the amperage load on the auger drive exceeds a desired maximum set point by a first amount while the sweep is being driven forwardly into a grain pile in the grain bin, the advancement of the sweep into the grain pile is slowed or stopped until the amperage load on the auger drive falls back to, or below, the desired maximum set point.

2. The method of claim 1 whereby, if the amperage load on the auger drive exceeds said desired maximum set point by a second amount larger than the first amount while the sweep is being driven forwardly into a grain pile in the grain bin, the direction of the sweep is reversed to remove the sweep from the grain pile; the rearward direction of the sweep being maintained until the amperage load on the auger drive falls to or below the desired maximum set point, at which time, the direction of the sweep drive motor is reversed to again drive the sweep into the grain pile.

3. The method of claim 1 whereby if the amperage load on the auger drive falls below a desired minimum set point, the speed of the advancement of the sweep into the grain pile will be increased until the amperage load on the auger drive is between the desired maximum set point and the desired minimum set point.

4. The method of claim 1 comprising controlling the bin sweep drive motor until it is determined that the grain bin is empty.

5. The method of claim 4 wherein the step of determining if the grain bin is empty comprises monitoring the amperage load on the auger drive; whereby, it is determined that the grain bin is empty if the amperage load on the auger drive drops below the desired minimum set point by a determined amount for a determined period of time.

6. The method of claim 4 wherein the step of determining if the grain bin is empty comprises monitoring the angular position of the bin sweep and determining if the bin sweep has completed a full revolution about an axis of rotation.

7. A method for controlling the travel of a bin sweep inside of a grain bin, the bin sweep comprising an auger, an electric auger drive which drives the auger; and a variable speed electric sweep drive motor which rotationally drives the bin sweep about an axis of rotation; the method comprising monitoring the amperage of the auger drive and electronically and automatically controlling the speed of the sweep drive motor based on the amperage load of the auger drive to adjust the speed of advancement of the sweep into a grain pile to maintain the amperage load on the auger drive within a predetermined amperage load range; said load range having an upper limit and a lower limit.

8. The method of claim 7 whereby if the amperage load on the auger drive exceeds said upper limit of the desired set point range by at least a determined amount, the direction of the sweep is reversed to remove the sweep from the grain pile; the rearward direction of the sweep being maintained until the amperage load on the auger drive falls to or below the upper limit of the desired set point range, at which time, the direction of the sweep drive motor is reversed to again drive the sweep into the grain pile.

9. The method of claim 7 comprising a step of determining the approximate unload rate of grain based on the amperage load of the auger drive.

10. The method of claim 9 including a step of determining the approximate amount of grain removed up to a given point in time based on the approximate unload rate.

11. The method of claim 7 including an initial step of adjusting the auger drive speed and torque to begin unloading of grain.

12. The method of claim 11 wherein including a step of delaying activation of the sweep drive until the load amperage on the auger drive falls below a determined threshold.

13. The method of claim 10 wherein the bin sweep comprises an auger shield which, at least in part, covers the auger; said initial step further including a step of retracting the shield to achieve a set auger drive load amperage.

14. A control system for controlling the direction of travel of a bin sweep assembly in a grain bin;
the bin sweep assembly comprising:
an auger assembly having an auger driven by an electric auger drive; and
a bin sweep drive which drives the auger rotationally about a center point; the bin sweep drive comprising a reversible motor;
the control system comprising a controller which is in operative communication with the bin sweep drive to activate and deactivate the bin sweep drive motor and to switch the bin sweep drive motor between a forward direction and a reverse direction; the controller also being in electrical communication with said auger drive to receive signals indicative of the amperage load of the auger drive; the controller controlling the bin sweep drive in response to the signals received regarding the amperage load of the auger drive to maintain the auger drive within a predetermined amperage load range, the load range having an upper limit and a lower limit.

15. The control system of claim 14 wherein the sweep drive is a variable speed drive, the controller controlling the speed of the sweep drive, and hence the speed with which the sweep is advanced into a grain pile, in response to the signals regarding the amperage load of the auger drive to maintain the auger drive within said predetermined amperage load range.

16. The control system of claim 14 wherein, if the controller determines that the amperage load on the auger drive exceeds the upper limit of the desired load range by a first amount, the controller stops advancement of the sweep into the grain pile.

17. The control system of claim 14 wherein the controller determines the amperage load on the auger drive to exceed the upper limit of the load range by a second determined amount, the controller reverses the direction of the sweep drive motor to remove the sweep from the grain pile; the rearward direction of the sweep being maintained until the amperage load on the auger drive falls to or below the upper limit of the load range, at which time, the controller reverses the direction of the sweep drive motor to again drive the sweep into the grain pile.

18. The control system of claim 14 wherein the sweep drive is a positive drive.

19. The control system of claim 18 wherein the bin sweep drive motor is an electric motor.

20. The control system of claim 14 wherein the controller controls the direction of the sweep until the controller determines that the grain bin is empty, or nearly empty, of grain.

21. The control system of claim 14 wherein the controller is adapted to determine the approximate unload rate of grain based on the amperage load of the auger drive.

22. The control system of claim 16 wherein the controller is adapted to determine the amount of grain unloaded up to a given point in time based on the approximate unload rate.

23. The control system of claim 14 further including a position encoder secured to the sweep assembly; said encoder being in electrical communication with said controller; said encoder emitting signals indicative of the angular position of the sweep in the grain bin.

24. The control system of claim 23 wherein the controller is adapted to determine if the bin is empty of grain based on the angular position of the sweep relative to the initial angular position of the sweep.

25. The control system of claim 14 wherein the grain bin sweep comprises two or more sweep assemblies.

26. The control system of claim 25, wherein each of the two or more sweep assemblies are independently controlled by the controller.

27. The control system of claim 25, wherein each of the two or more sweep assemblies are controlled by the controller to move in unison.
